(19) United States
(12) Patent Application Publication
(10) Pub. No.: US 2011/0260889 A1
(43) Pub. Date: Oct. 27, 2011

(54) ELECTRICAL STIMULATION SYSTEM AND PROCESS

(76) Inventor: Jay G. Hill, Renton, WA (US)

(21) Appl. No.: 12/767,760

(22) Filed: Apr. 26, 2010

(51) Int. Cl. G08B 21/00

(52) U.S. Cl. 340/945

(57) ABSTRACT

A method and apparatus to electrically stimulate a driver of a vehicle using a Transcutaneous Electrical Nerve Stimulation (TENS) device is disclosed. A signal supplied to or received from a vehicle instrument indicating operational characteristics of a vehicle is monitored. A determination is made from the signal when the vehicle characteristics exceed predetermined parameters. In response to the determination, electrically stimulating a user of the vehicle. The amount of the electrical stimulation from the TENS device is then varied based on the determination.

### TECHNICAL FIELD

These claimed embodiments relate to a method for stimulating a user of a vehicle and more particularly to electrically stimulating a user of a vehicle based on changes to characteristics of the vehicle.

### BACKGROUND OF THE INVENTION

A method and apparatus for electrically stimulating a user of a vehicle is disclosed.

Pilots can become dangerously bored during the routine of commercial flying. This concern is substantiated by the examples of pilots that lose track of time, distance and perhaps even “control” of their airplane and flew past their destination.

Technology has been incorporated into an airplane's autopilot, which has been used to assist the pilot by automatically flying the airplane. Technology lulls pilots into false sense of security. Technological advances have created a “subtle disconnect” between pilots and their aircraft. Highly automated aircraft's can leave pilots so detached from flying that they become almost like passengers on their own flights. Unfortunately pilots can become comfortable and bored with long flights if they are regularly exposed to the autopilot for extended lengths of time.

### SUMMARY OF THE INVENTION

In one implementation a method is disclosed that develops a socially acceptable method that keeps the pilot alert and engaged with the piloting of the airplane (or any vehicle) during each and every flight.

A body suit is fitted to the pilot that has either Transcutaneous Electrical Nerve Stimulation (TENS) or a similar device for feeding an electrical stimulus to the pilot/user. The TENS inputs is connected to instruments critical to the pilot's attention. The amplitude/rate/intensity of stimulation would be varied depending on the individual's needs and signals provided from the instruments. This stimulation would give the pilot the “feel” of the airplane and would result in a release of endorphins that would keep the pilot at an optimum level of arousal during the entire flight. These endorphins can promote a very enjoyable feeling and would the pilot people awake, stimulated and focused.

In one implementation, a system is disclosed including a controller to monitor characteristics of vehicle instruments critical to maintaining movement of the vehicle and to determine when the vehicle characteristics exceed predetermined parameters. The controller in response to the determination provides an electrical stimulation to a user of the vehicle. The controller vanes an amount of the electrical stimulation depending on whether the monitored vehicle characteristics exceed the predetermined parameters or based on characteristics of the user.

A process for stimulating a user or driver of a vehicle is also disclosed. The process includes monitoring a signal supplied to or received from an instrument on the vehicle. The signal indicates operational characteristics of a vehicle. A determination is made from the signal as to when the vehicle characteristics exceed predetermined parameters. In response to the determination, a user of the vehicle is electrically stimulating using a TENS device. The amount of the electrical stimulation is also varied based on the determination.

In addition, a computer readable storage medium comprising instructions is disclosed. The instructions when executed by a processor monitor a signal supplied to or received from a vehicle instrument, the signal indicating operational characteristics of a vehicle. A determination is made from the signal when the vehicle characteristics exceed predetermined parameters. An indication to electrically stimulate with a Transcutaneous Electrical Nerve Stimulation (TENS) is provided to a user of the vehicle and an amount of the electrical stimulation is varied based on the determination.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a voltage control system for regulating power.

FIG. 2 is a simplified schematic diagram of a voltage signal processing element that processes measured voltage signals to provide a selected voltage signal for tap regulation.

FIG. 3 is a flow chart determining a voltage adjustment decision by voltage controller shown in FIG. 1.

### DETAILED DESCRIPTION

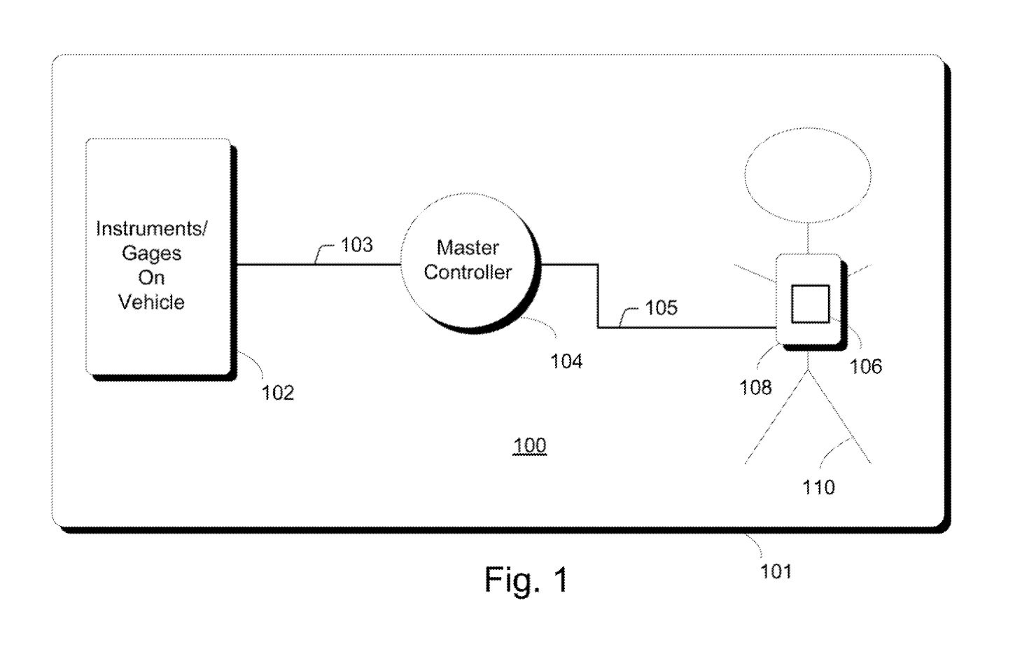

Referring to FIG. 1, there is shown a system 100 residing in a vehicle 101. System 100 includes a master controller 102 electrically connected to an instrumentation panel 104 via line 103 and a Transcutaneous Electrical Nerve Stimulation (TENS) device 106 via line 105. In one implementation, the master controller 102 may be connected to the TENS device 106 via an interface circuit that converts the level of the voltage or protocol of the signal from the master controller 102 to voltage levels or protocols compatible with the TENS device 106. The TENS device 106, in one implementation, may be positioned on a flight suit 108 of user 110. Although a vehicle 101 is described in FIG. 1, vehicle 101 may be any device that can be used for transportation including, but not limited to, an aircraft, an automobile, a train, a motorcycle, a bicycle or a watercraft.

Master controller 104 receives signals from instrument panel 102 via line 103. The signals indicate characteristics of the vehicle including characteristics of the aircraft critical to maintaining the vehicle's operation. Examples of such signals (and the instrumentations being monitored) include an airspeed indicator (knots), artificial horizon, vertical speed indicator (rate of climb), altimeter, directional gyro (compass), turn and bank indicator, aircraft attitude, a navigation indication, a hydraulics indication, a fuel flow indication, ground proximity indication, a stick shaker indication, a gear retract/extend indication, a brake energy limit indication, a cabin air conditioning indication, a vertical speed indication, other aircraft proximity indication, ice and rain indications, anti-skid indication, a brake energy indication, a cabin pressurization indication, emergency equipment indication, a weight and balance indication, an autopilot activation indication, an engine pressure ratio indication, an engine functioning indication, a flight management computer activation indication, and a dispatch deviation indication.

The signal may be provided to master controller 104 directly via line 103 from one of the above instruments/indicators 102 or may be provided as an output from one of the gages on the instrument panel on the vehicle 101.

The master controller 104 determines the magnitude of each of the signals from the gages/indicators 102. If the magnitude of one or more of the signals exceeds a predetermined value for a predetermined time period, the master controller feeds a signal to the TENS device 106 via line 105. The predetermine value may be set to a level to indicate that the instrument 102 being monitored has exceed standard operating parameters or could cause the vehicle to crash and/or fail. The signal fed to the TENS device 106 may indicate the magnitude of the one or more signals, may indicate that one or more of the gages have exceeded the predetermined value for the predetermined time period, or may indicate that a subset of the instruments/gages have exceeded the predetermined value for the predetermined time period. The TENS device 106, stimulates the user based on indications of the signal received from the master controller 102. In one implementation, the signal from the master controller 102 may indicate to the TENS device 106 to provide stimulation with increased intensity if a subset of the instruments and/or gages have exceeded the predetermined value for the predetermined time period. In another implementation, the master controller 102 may indicate to the TENS device 106 to provide a stimulation with increased intensity if any of the instruments/gages have exceeded the predetermined value.

The TENS device 106 is attached to the pilot 110 and injects one or more small electrical charge onto the body of a pilot 110 of a vehicle (also referred to herein as a user 110) via line 105. The electric charge may be a continuous charge, a single charge having a predetermined duration, or may be a charge comprising multiple pulses or a burst of multiple pulses. The charge, duration of the charge or number of pulses may be proportional to the voltage level received from the master controller 104 or may be indicated in signal received from the master controller 104. In one implementation, the TENS device 106 is coupled with or includes a switch/dial and an integrated electrical amplifier (not shown) to allow the user 110 to increase the magnitude of the charge. The TENS device 106 may be manufactured by Tensunit.com company of Largo, Fla. The TENS device 106 works by sending stimulating pulses across the surface of the skin and along the nerve strands. The stimulating pulses stimulate a user's body to produce higher levels of its own natural painkillers, called “Endorphins”.

The TENS device 106 is placed in contact with the user 110 using a generally known attachment device, or may be placed in a specially designed suit (e.g. a stim-suit) 108 and automatically attached to the user 110 when the user 110 puts on the suit. The stim-suit 108 may be any suit that holds the TENS device 106 in place during operation. This stim-suit 108 and device 106 in response to the signal from the master controller 102 could provide both increased situational awareness by increasing or maintaining the user's level of arousal. In one implementation, the TENS device 106 is attached to the lower back of the user. The TENS device 106 but may be attached to any part of the body of user 110.

### Example Master Controller Architecture

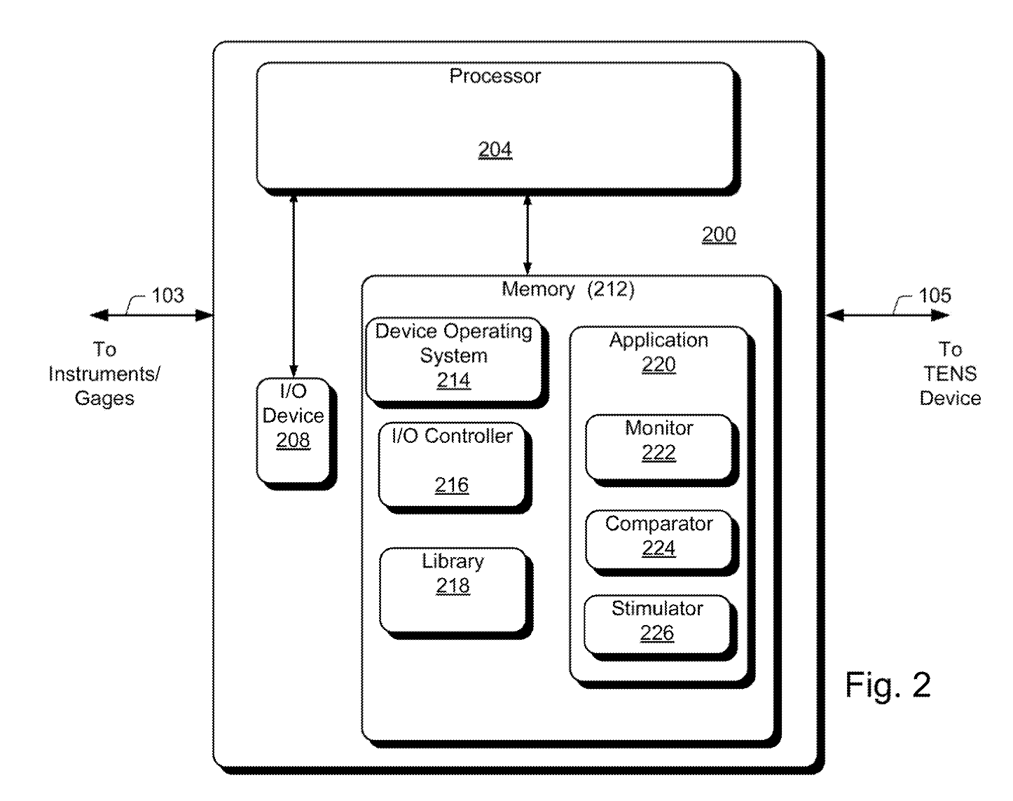

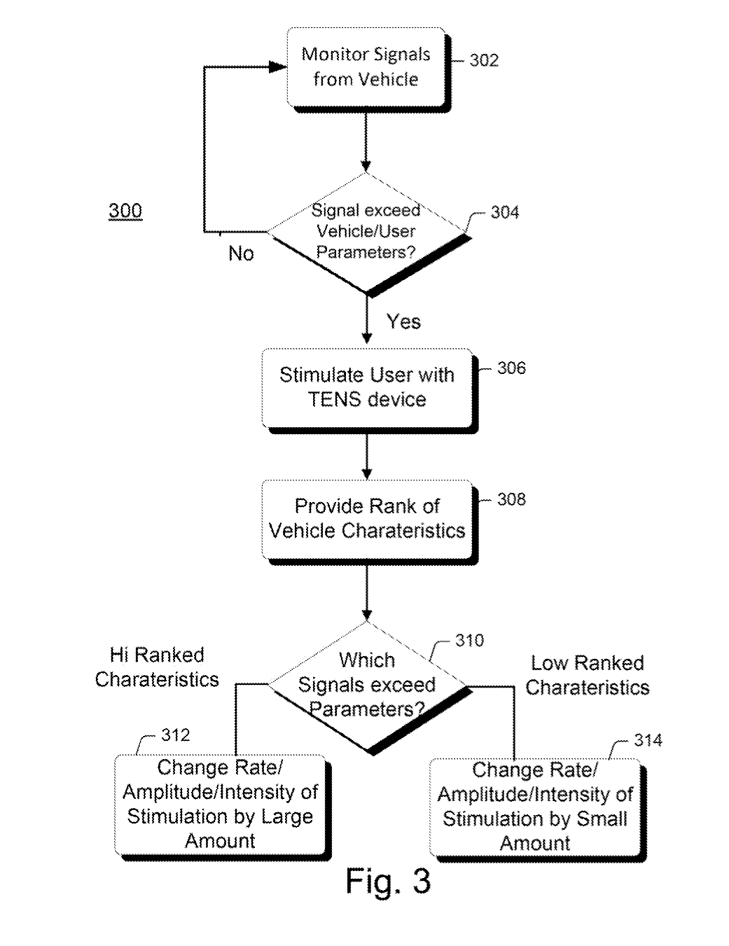

In FIG. 2 are illustrated selected modules in Master Controller 200 (Master controller 104 of FIG. 1) using process 300 shown in FIG. 3. Master Controller 200 includes a processor 204 coupled with memory 212 (also referred to a computer readable store device) and input/output device 208. Input/output device 208 transmits and receives signals with the instrument panel/gages (or directly with the instruments themselves) via line 103 and transmits and receives signals from the TENS device 106 via line 105.

The memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which h can be accessed by a computer system. Processor 204 may include a microprocessor, and executes instructions that are stored in memory 212. Examples of instructions that are stored in memory 212 are described in FIG. 3.

Stored in memory 212 of the computing device 200 are operating system 214 (Such as a Window® Mobile, Linux, Apple® or a real time operating systems), I/O controller 216, libraries 218 and software application 220 (in which code is stored for running the TENS application). Software application 220 includes monitoring module 222, comparator module 224, and stimulator module 226.

Illustrated in FIG. 3, is a process 300 for electrically stimulating a user in response to characteristics of a vehicle being monitored. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 3, although it may be implemented in other system architectures.

Referring to FIG. 3, a process 300 is shown for determining electrically stimulating a user using the processor and modules shown in FIG. 2. In process 300, signals from instruments in a vehicle (See FIG. 2) are monitored in block 302 using monitor module 222 in the master controller 200 (FIG. 2). The signals may be monitored by tapping directly into gages on an instrument patent on the vehicle, or by directly monitoring the instrument patent. In block 304, a determination is made by comparator module 224 in the master controller 200 as to whether the monitored signals (or signal) have exceeded the vehicle parameters that could cause the vehicle to malfunction. The comparator module could also indicate that the signals have exceeded parameters preset by a user/driver of the vehicle.

If the signals have not exceeded the parameters (No in block 304), the signals from the vehicle will continue to be monitored in block 302. If the signals have exceeded the predetermine parameters, in block 306 stimulator module 226 provides an indication to I/O device 208 to send a signal via line 105 (FIGS. 1 and 2) to TENS device 106 to electrically stimulate the user/driver of the vehicle.

In one implementation, a ranking may be made of the vehicle characteristics in block 308. The ranking may be done based on the importance or criticality of the vehicle, or as to which of the vehicle characteristics are more likely (upon exceeding standard operating parameters) to result in the vehicle crashing or failing.

For example for an airplane, the vehicle characteristics/or genres are ranked as follows: 1. Aviation characteristics, e.g. those characteristics of the airplane necessary to allow the airplane to fly. Example of aviation characteristics that can be monitored includes airspeed, artificial horizon, vertical speed, altimeter, turn and bank) 2. Navigation characteristics, including compass and directional indicators. 3. Communication characteristics (e.g. radio operation) and 4. Airplane System management, (e.g. cabin air conditioning, lights on in the cabin, auxiliary power unit, auto start of engines). In one implementation characteristics 1. and 2. are high ranked characteristics and characteristics 3. and 4. are low ranked characteristics.

In block 310, a determination is made by comparator 224 in master controller 200 (FIG. 2) as to which of the signals received from the instruments on line 103 exceed predetermined parameters. These predetermined parameters may be set by a user or as a factory default settings.

If any of the signals are high ranked characteristics, a master controller 200 in block 312 initiates the transmission of a first signal using I/O device 208 and via line 105 to the TENS device 106 (FIG. 1). The first signal indicates that the TENS device 106 should change the TENS stimulation pulse rate, amplitude, or intensity of the stimulation by a relatively large amount.

If the signals are from low ranked characteristics, a master controller 200 in block 314 initiates the transmission of a second signal using I/O device 208 and via line 105 to the TENS device 106. The second signal indicates that the TENS device 106 should change the TENS stimulation pulse rate, amplitude, or intensity of the stimulation by a relatively small amount.

The TENS device 106 could be programmed electronically or using a dial to provide a further increased or decreased stimulation based on characteristics of the user/driver of the vehicle. For example if the user (user 110 FIG. 1) is an individual who is not very sensitive or has built up an immunity to the TENS device 106, the intensity, rate or amplitude of the TENS device 106 could be increased or dialed up. On the other hand, if the user 110 is an individual who is very sensitive to the TENS device 106, the intensity, rate or amplitude of the TENS device 106 could be decreased or dialed down.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method comprising:
monitoring a signal supplied to or received from a vehicle instrument, the signal indicating operational characteristics of a vehicle;
determining from the signal when the vehicle characteristics exceed predetermined parameters;
in response to the determination, electrically stimulating a user of the vehicle; and
varying the amount of the electrical stimulation based on the determination.

2. The method as recited in claim 1, wherein electrically stimulating a user of the vehicle includes:
electrically stimulating the user using Transcutaneous Electrical Nerve Stimulation (TENS).

3. The method as recited in claim 2, wherein electrically stimulating the user using TENS includes electrically stimulating the user using a device that generates TENS and is disposed in a body suit.

4. The method as recited in claim 1, wherein varying the amount of the electrical stimulation:
varying an amplitude, a rate or an intensity of the electrical stimulation.

5. The method as recited in claim 1, wherein the signal indicating characteristics of operation of a vehicle indicates at least one of:
an airspeed indicator, a navigation indication, a hydraulics indication, a fuel flow indication, ground proximity indication, a stick shaker indication, a gear retract/extend indication, a brake energy limit indication, a cabin air conditioning indication, a vertical speed indication, other aircraft proximity indication, ice and rain indications, anti-skid indication, a brake energy indication, a cabin pressurization indication, emergency equipment indication, a weight and balance indication, an autopilot activation indication, an engine pressure ratio indication, an engine functioning indication, a flight management computer activation indication, and a dispatch deviation indication.

6. The method as recited in claim 1, wherein varying the amount of the electrical stimulation based on the determination comprises varying the amount of electrical stimulation depending on the amount the vehicle characteristics exceed the predetermined parameters.

7. The method as recited in claim 1, wherein varying the amount of the electrical stimulation based on the determination comprises varying the amount of electrical stimulation depending on or characteristics of the user.

8. The method as recited in claim 1 wherein varying the amount of the electrical stimulation based on the determination comprises:
providing a ranking of the vehicle characteristics; and
providing a larger electrical stimulation upon determining that the vehicle characteristics exceed predetermined parameters for those vehicle characteristics having a higher ranking, and providing a smaller electrical stimulation upon determining that the vehicle characteristics exceed predetermined parameters for those vehicle characteristics having a lower ranking.

9. The method as recited in claim 8, wherein the vehicle characteristics include an aviation indication, a navigation indication, a communication indication and a manage system operation indication.

10. The method as recited in claim 9, wherein the vehicle characteristics are ranked in order wherein the aviation indication is the highest ranked vehicle characteristic and the manage system operation indication is the lowest ranked vehicle characteristic.

11. A system comprising:
a controller to monitor characteristics of vehicle instruments critical to maintaining movement of the vehicle and to determine when the vehicle characteristics exceed predetermined parameters, said controller in response to the determination, to provide an electrical stimulation to a user of the vehicle, and said controller to vary an amount of the electrical stimulation depending the monitored vehicle characteristics exceed the predetermined parameters or based on characteristics of the user.

12. The system as recited in claim 11 wherein monitoring vehicle characteristics critical to maintaining operation of the vehicle comprises monitoring vehicle instruments.

13. The system as recited in claim 11, further comprising a Transcutaneous Electrical Nerve Stimulation (TENS) device to electrically stimulate the user.

14. The system as recited in claim 13, further comprising a body suit adapted to fit the user, and wherein the Transcutaneous Electrical Nerve Stimulation (TENS) device is disposed in the body suit.

15. The system as recited in claim 11, wherein the controller is adapted to vary the amplitude or rate or intensity of the electrical stimulation.

16. A computer readable storage medium comprising instructions which when executed by a processor comprises:
monitoring a signal supplied to or received from a vehicle instrument, the signal indicating operational characteristics of a vehicle;
determining from the signal when the vehicle characteristics exceed predetermined parameters; and
providing an indication to electrically stimulate with a Transcutaneous Electrical Nerve Stimulation (TENS) device a user of the vehicle and to vary an amount of the electrical stimulation generated by the TENS device based on the determination.

17. The computer readable storage medium as recited in claim 16, wherein the vehicle is an airplane, and wherein the vehicle characteristic is an indication selected from the group of airplane indications comprising:
an airspeed indicator, a navigation indication, a hydraulics indication, a fuel flow indication, ground proximity indication, a stick shaker indication, a gear retract/extend indication, a brake energy limit indication, a cabin air conditioning indication, a vertical speed indication, other aircraft proximity indication, ice and rain indications, anti-skid indication, a brake energy indication, a cabin pressurization indication, emergency equipment indication, a weight and balance indication, an autopilot activation indication, an engine pressure ratio indication, an engine functioning indication, a flight management computer activation indication, and a dispatch deviation indication.

18. The computer readable storage medium as recited in claim 16, further comprising instructions which when executed by a processor comprises:
providing a ranking of the vehicle characteristics; and
providing a larger electrical stimulation upon determining that the vehicle characteristics exceed predetermined parameters for those vehicle characteristics having a higher ranking, and providing a smaller electrical stimulation upon determining that the vehicle characteristics exceed predetermined parameters for those vehicle characteristics having a lower ranking.

19. The computer readable storage medium as recited in claim 16, wherein varying the amount of the electrical stimulation of the TENS device comprises:
varying an amplitude, a rate or an intensity of the electrical stimulation generated by the TENS device.
